(19) United States
(12) Patent Application Publication
(10) Pub. No.: US 2025/0385780 A1
(43) Pub. Date: Dec. 18, 2025

(54) FAST PARALLELIZABLE MULTI-KEY FULLY HOMOMORPHIC ENCRYPTION BASED ON NTRU

(71) Applicant: Jinan University, Guangzhou (CN)

(72) Inventors: Jian WENG, Guangzhou (CN); Zhen HAN, Guangzhou (CN); Yuan JI, Guangzhou (CN); Zikai SONG, Guangzhou (CN); Yuteng WANG, Guangzhou (CN); Junzuo LAI, Guangzhou (CN); Zhiquan LIU, Guangzhou (CN); Ming LI, Guangzhou (CN); Bingwen FENG, Guangzhou (CN); Jiasi WENG, Guangzhou (CN)

(21) Appl. No.: 19/315,768

(22) Filed: Sep. 1, 2025

(51) Int. Cl. H04L 9/06; H04L 9/00; H04L 9/08

(52) U.S. Cl. CPC H04L 9/0618; H04L 9/008; H04L 9/0861

(57) ABSTRACT

The present application describes a multi-key fully homomorphic encryption (MK-FHE) scheme that enables secure and efficient multi-party computation by integrating learning with errors (LWE), ring learning with errors (RLWE), and NTRU-based encryption primitives. The scheme supports dynamic key management, parallelizable bootstrapping, and low-overhead homomorphic operations. Key innovations include a hybrid product mechanism for merging ciphertexts across cryptographic structures, a single-key blind rotation algorithm optimized for Fourier domain operations, and a noise-refreshing procedure that bounds error growth during homomorphic evaluations. This scheme achieves quasi-linear time complexity relative to the number of participating parties, making it suitable for resource-constrained environments such as federated learning and secure cloud-based AI inference.

### TECHNICAL FIELD

The present disclosure relates to the field of homomorphic encryption, particularly to a multi-key fully homomorphic encryption (MK-FHE) scheme. The disclosure provides a system and method for secure multi-party computation with parallelizable bootstrapping mechanisms. This enables efficient processing of encrypted data under multiple independent keys while reducing computational and hardware resource requirements.

### BACKGROUND

Fully Homomorphic Encryption (FHE) allows computations on encrypted data without decryption, enabling privacy-preserving applications such as cloud computing, federated learning, and secure artificial intelligence (AI) inference. Traditional FHE schemes assume a single public key for encryption, which limits their applicability in multi-party scenarios where participants use independent keys. Two approaches address this limitation: Threshold FHE and Multi-Key FHE (MK-FHE). Threshold FHE uses a shared public key with distributed secret keys but is restricted to static participant sets, lacking flexibility. MK-FHE, conversely, allows each participant to generate independent key pairs, supporting dynamic participation and joint evaluation of ciphertexts under different keys.

Prior MK-FHE schemes, such as those by López-Alt et al., demonstrated feasibility but were limited by static keys and bounded participant counts. Later advancements, like those by Peikert and Shiehian, introduced dynamic key support but incurred high computational overhead. NTRU-based MK-FHE schemes, valued for compact ciphertexts, faced vulnerabilities like sublattice attacks, necessitating large moduli that increased resource demands. Recent TFHE-based MK-FHE schemes improved efficiency but relied on large bootstrapping keys, making them impractical for resource-constrained environments, such as edge devices or low-power servers.

Existing MK-FHE frameworks struggle with inefficient bootstrapping for multi-key ciphertexts, failing to balance security (e.g., avoiding overstretched parameters) and performance. Bootstrapping, a critical process for refreshing ciphertexts to manage noise growth, is computationally intensive in multi-key settings, often requiring significant memory and processing power. These limitations hinder scalability and deployment in real-world applications, particularly those involving dynamic participant sets or constrained hardware.

There remains an unmet need for an MK-FHE scheme that supports dynamic key inclusion, provides efficient parallelizable bootstrapping, and maintains robust security under standard cryptographic assumptions while minimizing hardware requirements.

### SUMMARY

The present disclosure addresses these challenges by providing a novel MK-FHE scheme based on NTRU, incorporating parallelizable bootstrapping and hybrid ciphertext merging. The present disclosure provides the following schemes.

A computer-implemented method for multi-key fully homomorphic encryption, comprising:
generating a unified set of public parameters defining operational moduli and dimensions for learning with errors (LWE), ring learning with errors (RLWE), and NTRU-based encryption schemes;
producing, for each participant in a plurality of participants, independent cryptographic keys comprising a secret key pair for encryption and decryption operations, and a hybrid product key enabling merging of ciphertexts across LWE and RLWE structures;
transforming plaintext data into an initial encrypted form under a participant's secret key, yielding a participant-specific ciphertext compatible with LWE structures;
aggregating participant-specific ciphertexts from the plurality of participants to form a composite ciphertext operable under multiple keys;
conducting homomorphic evaluation of a logical operation on at least two composite ciphertexts, incorporating a noise-refreshing procedure that: integrates single-element LWE-based encrypted structures with multi-element RLWE-based encrypted structures through a gadget decomposition and tensor product-based multiplication process to generate an updated composite ciphertext; and
recovering the evaluated plaintext from the updated composite ciphertext by collaboratively applying the secret keys of all relevant participants.

Preferably, the step of generating a unified set of public parameters defining operational moduli and dimensions for LWE, RLWE, and NTRU comprises specifying an integer modulus q for LWE operations and a polynomial ring modulus Q for RLWE and NTRU operations; specifying a vector dimension n for LWE secrets and a polynomial ring dimension N for RLWE/NTRU secrets; and specifying noise distributions, gadget decomposition bases, and error bounds for all three encryption schemes.

Preferably, the secret key pair comprises an LWE secret vector

$${s}_{i} ∈ {ℤ}_{q}^{n}$$

and an

RLWE secret key zᵢ ∈ R_{Q}; the hybrid product key is generated by sampling random elements rᵢ←χ_{σ}_{_{β}} and noise vector

$${e}_{i , 0} ← {𝒳}_{{σ}_{β}}^{{d}_{hp}} ,$$

computing

$${d}_{i , 0} = {r}_{i} \cdot a + {f}_{i} \cdot 𝔤 + {e}_{i , 0} ∈ {R}_{Q}^{{d}_{hp}} ,$$

computing

$${d}_{i , 2} = - {z}_{i} \cdot {d}_{i , 1} + {r}_{i} \cdot 𝔤 + {e}_{i , 1} ∈ {R}_{Q}^{{d}_{hp}} ,$$

and outputting a product key pair (d_{i,1}, d_{i,2}), a ciphertext merging key set is NKSK={nkskᵢ}_{0≤i≤d-1}, where

$${nksk}_{i} = {NTRU}_{f , Q}^{′} ( {B}^{i} ) .$$

Preferably, the step of transforming plaintext data into an initial encrypted form under a participant's secret key comprises sampling a random vector

$${a}_{i} ← {ℤ}_{q}^{n}$$

and noise term e from a distribution χ_{σ}, computing a ciphertext component

$$b = - 〈 {a}_{i} , {s}_{i} 〉 + \frac{q}{4} m + e ,$$

and outputting the ciphertext as a pair

$$( b , {a}_{i} ) ∈ {ℤ}_{q} \times {ℤ}_{q}^{n} ,$$

wherein sᵢ is the participant's LWE secret key.

Preferably, aggregating participant-specific ciphertexts from a plurality of participants by: receiving single-party LWE ciphertexts

$${c}_{j} = ( {b}_{j} , {a}_{j} ) ∈ {ℤ}_{q}^{n + 1}$$

for 1≤j≤k, where each cⱼ is encrypted under a distinct participant's secret key; computing a joint offset term

$${b}_{sum} = {\sum }_{j = 1}^{k} {b}_{j} ∈ {ℤ}_{q} ,$$

concatenating ciphertext vectors to form

$${a}_{joint} = ( {a}_{1} , … , {a}_{k} ) ∈ {ℤ}_{q}^{kn} ;$$

outputting a composite ciphertext

$$\overline{ct} = ( {b}_{sum} , {a}_{joint} ) ∈ {ℤ}_{q}^{kn + 1} ;$$

wherein the composite ciphertext is operable under a combination of all participants' secret keys for homomorphic evaluation or decryption.

Preferably, the noise-refreshing procedure during homomorphic evaluation comprises: computing decomposed components for each index j from 0 to d−1:vⱼ=c⊙nkskⱼ, constructing a gadget vector v=(v₀, v₁, . . . , v_{d-1}), computing

$${c}_{j}^{′} = {𝔤}^{- 1} ( {c}_{j} ) \cdot v mod Q$$

and forming intermediate ciphertext

$$\hat{c} = ( {c}_{0}^{′} , {c}_{1}^{′} , … , {c}_{k}^{′} ) ,$$

applying HybridProduct to ê using public keys {bⱼ}_{j∈[k]}.

Preferably, recovering the evaluated plaintext comprises: computing an inner product between the updated composite ciphertext

$$\overline{ct} = ( {\sum }_{j = 1}^{k} {b}_{j} , {a}_{1} , … , {a}_{k} ) ∈ {ℤ}_{q}^{kn + 1}$$

and the aggregated secret key vector (1, s̅), where s̅=(s₁, . . . sₖ) is the concatenation of all participants' secret keys, scaling and discretizing the result to recover a plaintext bit

$$m = ⌊ \frac{2}{q} ( 〈 \overline{ct} , ( 1 , \overline{s} ) 〉 ) ⌉ ∈ \{ 0 , 1 \} .$$

Preferably, the noise-refreshing procedure comprises: initializing an accumulator ACC, executing blind rotation BREval in a Fourier domain, and merging ciphertexts via HybridProduct with noise variance bounded by: σ²≤k·dₕₚ·N²·Vₕₚ·σ_{β}², where k denotes the number of participants, dₕₚ denotes gadget decomposition dimension, N denotes ring dimension of RLWE/NTRU (R_{Q}=Z_{Q}[X]/(X^{N}+1)), Vₕₚ denotes variance bound of gadget base B, σ_{β}² denotes variance of RLWE noise distribution.

Preferably, the blind rotation algorithm BREval comprises: scaling coefficients

$${a}_{i}^{′} = \frac{2 N}{q} {a}_{i} ,$$

initializing ACC=X^{a}^{₀}⊙evk₀, iteratively updating

$$ACC ⊙ [ g + ( {X}^{{a}_{i}^{′}} - 1 ) \cdot {evk}_{i} ]$$

for 1≤i≤n−1.

Preferably, the noise-refreshing procedure executes in quasi-linear time relative to the number of parties k.

Preferably, the noise-refreshing procedure further comprises a ModSwitch operation comprising: receiving a multi-key LWE ciphertext

$$c = ( {c}_{0} , … , {c}_{kn} ) ∈ {ℤ}_{Q}^{kn + 1} ,$$

applying randomized rounding to each component: [x]_{q:Q}=└qx/Q┘+B, and outputting a refreshed ciphertext

$${c}^{′} = {( {[ {c}_{i} ]}_{q : Q} )}_{0 \leq i \leq kn} ∈ {ℤ}_{q}^{kn + 1} .$$

Preferably, the noise-refreshing procedure further comprises a KeySwitch operation comprising: receiving a multi-key LWE ciphertext

$$\overline{ct} = ( b , {a}_{1} , … , {a}_{k} ) ∈ {ℤ}_{q}^{kn + 1} ,$$

for each participant j, 1≤j≤k, computing

$$( {b}_{j}^{′} , {a}_{j}^{′} ) = {\sum }_{i = 0}^{N - 1} {𝔤}^{- 1} ( {a}_{i , j} ) \cdot {lsks}_{j} ,$$

then outputting a transformed ciphertext

$$\overline{{ct}^{′}} = ( b + {\sum }_{i = 1}^{k} {b}_{i}^{′} , {a}_{1}^{′} , … , {a}_{k}^{′} ) .$$

According to another aspect of the present disclosure, a computing system configured for multi-key fully homomorphic encryption, comprises:
a central node configured to produce and disseminate a unified set of public parameters for LWE, RLWE, and NTRU-based encryption schemes; and
a plurality of participant nodes, each configured to: generate cryptographic keys including a secret key and a hybrid product key for ciphertext merging; convert plaintext data into a participant-specific ciphertext; contribute to aggregating participant-specific ciphertexts into a composite ciphertext; participate in homomorphic evaluation via a noise-refreshing procedure that integrates LWE and RLWE structures through gadget decomposition and tensor product-based multiplication; wherein the noise-refreshing procedure applies a Fourier transform-based rotation operation in a frequency domain.

Preferably, each participant node executes the noise-refreshing procedure by: performing tensor product-based multiplication with decomposition and vector assembly to bound error growth.

Preferably, the central node distributes parameters defining a noise distribution χ and gadget base B.

Preferably, each participant node performs the tensor product-based multiplication by constructing a vector v=(v₀, . . . , v_ {d−1}) via linear combinations of decomposed ciphertext components.

According to another aspect of the present disclosure, a non-transitory computer-readable storage medium storing instructions, when executed by one or more processors, cause the processors to perform the methods described above.

The core structure of the present disclosure includes:
1. Cryptographic Primitives: Utilizes Learning With Errors (LWE), Ring Learning With Errors (RLWE), and NTRU-based GSW-like encryption to construct a secure foundation for multi-key operations.
2. Single-Key Blind Rotation: Employs a blind rotation algorithm operating in the Fourier domain to manipulate encrypted data efficiently, reducing computational overhead.
3. Hybrid Ciphertext Merging: Combines scalar NTRU ciphertexts with multi-key RLWE ciphertexts via a hybrid product mechanism, optimizing noise management and compatibility.
4. Parallelizable Multi-Key Bootstrapping: Implements a bootstrapping algorithm that refreshes ciphertexts under multiple keys in parallel, significantly reducing computational time.
5. Core MK-FHE Algorithms: Includes Setup, KeyGen, Enc, Dec, and NAND operations, enabling dynamic key inclusion and evaluation of arbitrary circuits with quasi-linear time complexity.

The present disclosure has the following technical advantages. The disclosure leverages gadget decomposition and NTRU-based encryption to minimize noise growth during computations. The parallelizable bootstrapping algorithm reduces time complexity to quasi-linear in the number of parties, enabling faster processing compared to prior MK-FHE schemes that scale poorly with participant count. By optimizing ciphertext sizes through NTRU's compact structure and minimizing bootstrapping key sizes via blind rotation in the Fourier domain, the disclosure reduces memory and processing demands. This enables deployment on resource-constrained devices, such as edge devices or low-power servers, without sacrificing security. The scheme supports on-the-fly key addition, allowing new parties to join computations without reconfiguring the system, enhancing flexibility for applications like federated learning. Built on standard cryptographic assumptions (e.g., decisional KDM-form NTRU problem), the scheme avoids vulnerabilities like sublattice attacks by using carefully selected parameters, ensuring security without requiring oversized moduli.

### BRIEF DESCRIPTION OF THE DRAWINGS

FIG. 1 is a flowchart of the overall MK-FHE (Multi-Key Fully Homomorphic Encryption) process according to an embodiment of the present disclosure. It starts with the setup phase (MKHE.Setup) that calls sub-procedures for LWE, RLWE, and NTRU setup to generate public parameters. Then, it proceeds to key generation (MKHE.KeyGen) where LWE and RLWE secret keys are sampled, product keys and keyswitching keys are generated, and the keys are published. The encryption step (MKHE.Enc) samples random parameters and outputs an LWE ciphertext. The expansion step (MKHE.Expand) converts the LWE ciphertext to a multi-key ciphertext (MK-LWE). The NAND gate evaluation (MKHE.NAND) takes two MK-LWE ciphertexts, evaluates the NAND gate, and refreshes the result via multi-key bootstrapping. Finally, the decryption step (MKHE.Dec) uses the MK-LWE ciphertext and the secret key to compute the plaintext.

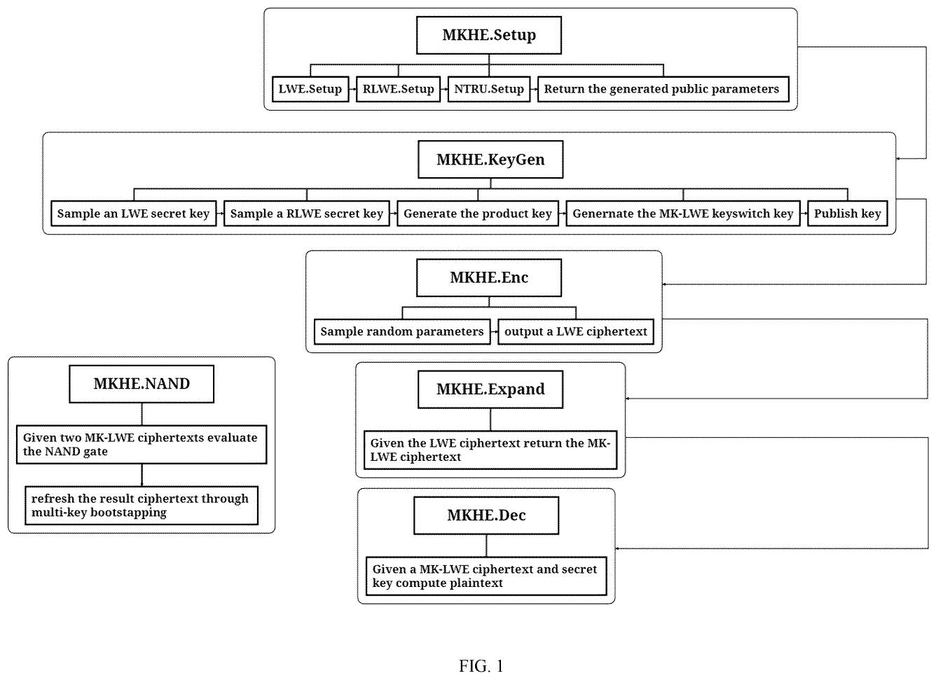

FIG. 2 illustrates a process involving multiple BREval (Blind Rotation Evaluation) operations and a subsequent merge. Each BREval block (two are shown, indexed 1 and k) processes a sequence of operations (brk_{1,0} to brk_{1.n-1} and brk_{k,0} to brk_{k,n-1}) and produces an output (ACC′₁ and ACC′ₖ). These outputs are then merged (Merge) into an accumulator (ACC), which is then processed to form an MK-RLWE ciphertext and finally transformed into an MK-LWE ciphertext.

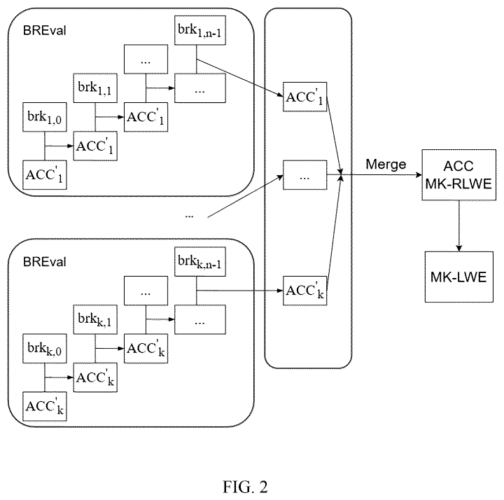

FIG. 3 shows the detailed steps of the NAND gate operation in a multi-key FHE scheme. Two MK-LWE ciphertexts (each in

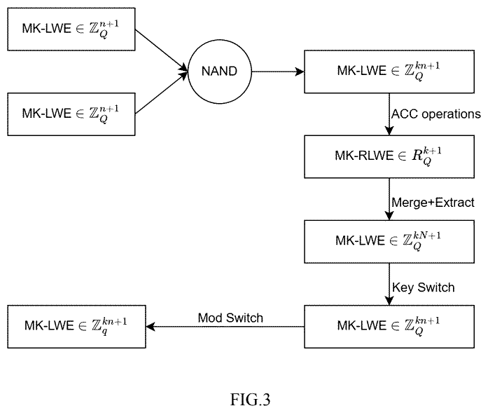

$${ℤ}_{Q}^{n + 1}$$

are input to a NAND gate. The output of the NAND is an MK-LWE ciphertext (in

$${ℤ}_{Q}^{k n + 1} ) .$$

This ciphertext then undergoes accumulator operations (ACC operations) to become an MK-RLWE ciphertext (in

$${R}_{Q}^{k + 1} ) .$$

The MK-RLWE is then processed by a “Merge+Extract” step to form an MK-LWE ciphertext in

$${ℤ}_{Q}^{kN + 1} .$$

This is then processed by Key Switch to another MK-LWE ciphertext in

$${ℤ}_{Q}^{kn + 1} .$$

Finally, Mod Switen is applied to output the last MK-LWE ciphertext in

$${ℤ}_{q}^{kn + 1} .$$

FIG. 4 is a schematic diagram of a computing system according to an embodiment of the present disclosure.

### DETAILED DESCRIPTION OF THE EMBODIMENTS

The present disclosure enables secure multi-party computation by performing homomorphic operations on encrypted data under multiple independent keys, with a parallelizable noise-refreshing procedure that leverages Fourier transform-based rotation, gadget decomposition, and tensor product-based multiplication. The description details of some embodiments of the method's steps, the system's architecture, and the hardware configuration required for implementation, emphasizing efficiency improvements and suitability for resource-constrained environments.

The following detailed description, in conjunction with the accompanying drawings, elaborates the MK-FHE scheme based on NTRU, focusing on its technical implementation and improvements over prior art. The scheme integrates cryptographic primitives such as LWE, RLWE, and NTRU-based GSW-like encryption, with a focus on parallelizable bootstrapping to enable efficient multi-party computations. Some embodiments of the detailed algorithms are described below, incorporating specific operational steps, noise management techniques, and references to the illustrative figures.

A fast parallelizable multi-key fully homomorphic encryption based on NTRU according to some embodiments of the present disclosure is described below. The MK-FHE scheme includes cryptographic primitives, bootstrapping mechanisms, and core algorithms.Setup: Generates public parameters for LWE, RLWE, and NTRU.KeyGen: Each party generates LWE/RLWE/NTRU keys, plus evaluation keys for bootstrapping. Enc: Encrypts a bit into an LWE ciphertext using the party's secret key. Expand: Combines single-party LWE ciphertexts into a multi-key LWE ciphertext. Dec: Decrypts a multi-key ciphertext using all participants secret keys. NAND: Evaluates a NAND gate on two multi-key ciphertexts and refreshes via bootstrapping.

The server generates public parameters for LWE, RLWE and NTRU, taking the security parameter λ, and returns a public parameter set pp. In particular, generate the parameter pp^{LWE}=(n, χ, σ_{α}, B, d, q), generate the parameter pp^{RLWE}=(N, χ, σ_{β}, B, d, a, Q), and generate the parameter pp^{NTRU}=(N, χ, σₑ, B, d, Q). Finally, return the generated public parameters pp^{MKHE}=(pp^{LWE}, pp^{RLWE}, pp^{NTRU}).

Each party generates LWE/RLWE/NTRU keys, plus evaluation keys for bootstrapping. Specifically, each party samples an LWE secret key

$${s}_{i} = ( {s}_{i , 0} , … , {s}_{i , n - 1} ) ∈ {ℤ}_{q}^{n} ,$$

a PLWE secret key zᵢ ∈ R_{Q}, and a noice vector

$${e}_{i} ← {𝒳}_{{σ}_{β}}^{d}$$

and compute

$${b}_{i} = - a \cdot {z}_{i} + {e}_{i} ∈ {R}_{Q}^{d} .$$

Generate the product key for NKSK product MK-RLWE: Firstly, using a RLWE secret key zⱼ ∈ R_{Q} and a NTRU secret key fᵢ ∈R_{Q} of party i. Sample rᵢ←ω_{σ}_{_{β}} and a noise vector

$${e}_{i , 0} ← {𝒳}_{{σ}_{β}}^{{d}_{hp}} ,$$

output the vector

$${d}_{i , 0} = {r}_{i} \cdot a + {f}_{i} \cdot 𝔤 + {e}_{i , 0} ∈ {R}_{Q}^{{d}_{hp}} .$$

### Sample

$${d}_{i , 1} ← {R}_{Q}^{{d}_{hp}}$$

and a noise vector

$${e}_{i , 1} ← {𝒳}_{{σ}_{β}}^{{d}_{hp}} ,$$

compute

$${d}_{i , 2} = - {z}_{i} \cdot {d}_{i , 1} + {r}_{i} \cdot 𝔤 + {e}_{i , 1} ∈ {R}_{Q}^{{d}_{hp}}$$

and output(d_{i,1},d_{i,2}).

Using a NTRU secret key f and gadget base B, the algorithm first leverages NTRU-related operations (consistent with the KDM—form NTRU framework where R_{Q}= [symbol] _{Q}[X]/(X^{N}+1), R= [symbol] [X]/(X^{N}+1), key distribution χₛ, noise distribution χₑ, etc.) to compute a set of ciphertexts. Then,

$${nksk}_{i} = {NTRU}_{f , Q}^{′} ( {B}^{i} )$$

and return NKSK={nkskᵢ}_{0≤i≤d-1}.

The evaluation key for Single-key blind rotation uses a secret key

$$s = ( {s}_{0} , … , {s}_{n - 1} ) ∈ {ℤ}_{q}^{n}$$

for the first-layer LWE encryption, and a secret key ƒ ∈ R_{Q} (aligning with the NTRU setup where fis sampled from the key distribution χₛ over R and projected to R_{Q} for the second-layer NTRU-based GSW-like encryption. When computing a set of ciphertexts:

$${evk}_{0} = {NTRU}_{Q , f}^{′} ( {s}_{0} / f ) , {evk}_{i} = {NTRU}_{Q , f}^{′} ( {s}_{i} )$$

for 1≤i≤n, with these NTRU encryption operations adhering to the KDM-form NTRU assumption's mathematical space (i.e., within the ring R_{Q} and using distributions χₛ, χₑ to ensure hardness properties as per the decisional KDM-form NTRU_{N,Q,}_{_{χs,χe}} problem, where distinguishing the constructed ciphertext distributions from random ones in R_{Q} is computationally hard for PPT algorithms.

Generate the MK-LWE keyswitch key. Use two LWE secret key z=(z₀, . . . , z_{N-1}) ∈ [symbol] ^{N} and s=(s₀, . . . , sₙ₋₁) ∈ [symbol] ⁿ, sample

$${A}_{i} ← {ℤ}_{q}^{d \times n}$$

and noise

$${e}_{i} ← {χ}_{σ}^{d}$$

for 0≤i≤N−1, then compute

$${b}_{i} = - {A}_{i} \cdot s + {e}_{i} + {z}_{i} \cdot 𝔤 ∈ {ℤ}_{q}^{d}$$

and output the keyswitch key lksk={(bᵢ, Aᵢ)}_{0≤j≤N-1}.

After key Generation, Each party Publish(bᵢ, hpkᵢ, NKSKᵢ, EVKᵢ, lkskᵢ).

Each party encrypts a bit into an LWE ciphertext using the party's secret key. Using a plaintext m ∈ {0,1}, party i sample

$${a}_{i} ← {ℤ}_{q}^{n} , e ← {χ}_{σ}$$

to output a LWE ciphertext

$${c}_{i} = ( - 〈 {a}_{i} , {s}_{i} 〉 + \frac{q}{4} m + e , {a}_{i} ) ∈ {ℤ}_{q} \times {ℤ}_{q}^{n} .$$

Each party Combines single-party LWE ciphertexts into a multi-key LWE ciphertext. Given

$${c}_{j} = ( {b}_{j} , {a}_{j} ) ∈ {ℤ}_{q}^{n + 1}$$

for 1≤j≤k, return the MK-LWE ciphertext

$$\overline{ct} = ( {\sum }_{j = 1}^{k} {b}_{j} , {a}_{1} , … , {a}_{k} ) ∈ {ℤ}_{q}^{k n + 1} .$$

Evaluates a NAND gate on two multi-key ciphertexts and refreshes via bootstrapping. This algorithm operates on a Multi-key LWE ciphertext

$$\overline{{ct}^{′}} ∈ {ℤ}_{q}^{k n + 1} .$$

First, it initializes ACC as

$$( - ⌊ \frac{Q}{8} ⌋ \cdot {X}^{\frac{2 N}{q} b} \cdot {\sum }_{- \frac{N}{2} < i < \frac{N}{2}} {X}^{i} , 0 ) ∈ {R}_{Q}^{k + 1} .$$

Then, for j from 1 to k, it invokes the BREval algorithm.

BREval((b, a),EVK) works as follows: First, iterate over i from 0 to n−1, and in each iteration, set

$${a}_{i}^{′} = \frac{2 N}{q} {a}_{i} .$$

Then, initialize ACC as ACC=X^{a}^{₀}⊙evk₀. Next, iterate over i from 1 to n−1, and in each iteration, update ACC as

$$ACC ⊙ [ g + ( {X}^{{a}_{i}^{′}} - 1 ) \cdot {evk}_{i} ] .$$

Finally, return ACC.

After that, for j from 1 to k again, the Merge algorithm is used to update ACC. The Merge algorithm functions as follows: It first iterates j from 0 to d−1, computing vⱼ=c⊙nkskⱼ.

Then, it constructs v=(v₀, v₁, . . . , v_{d-1}). Next, for j from 0 to k, it computes

$${c}_{j}^{′} = {𝔤}^{- 1} ( {c}_{j} ) \cdot v mod Q ,$$

forms

$$\hat{c} = ( {c}_{0}^{′} , {c}_{1}^{′} , ⋯ , {c}_{k}^{′} ) ,$$

and finally computes c̅ via HybridProduct(ĉ,hpkᵢ,{bⱼ}_{j∈[k]}) and returns ĉ.

It constructs v=(v₀, v₁, . . . , v_{d-1}). Next, for j from 0 to k, it computes

$${c}_{j}^{′} = {𝔤}^{- 1} ( {c}_{j} ) \cdot v mod Q ,$$

forms

$$\hat{c} = ( {c}_{0}^{′} , {c}_{1}^{′} , ⋯ , {c}_{k}^{′} ) .$$

To compute c̅, given the MK-RLWE ciphertext

$$\hat{c} = ( , … , ) ∈ {R}_{Q}^{k + 1} ) ,$$

hpkᵢ=(d_{i,0}, d_{i,1}, d_{i,2}) of party i, and public keys {bⱼ}_{j∈[k]} associated with ĉ: first, for 0≤j≤k, compute (uⱼ= [symbol] g⁻¹( [symbol] ), d_{i,0} [symbol] ); then compute

$$v = {\sum }_{j = 0}^{k} 〈 {𝔤}^{- 1} ( \hat{{c}_{J}} ) , {b}_{j} 〉 ;$$

next, construct the MK-RLWE ciphertext

$$\overline{c} = ( {c}_{0}^{′} , {c}_{1}^{′} , … , {c}_{k}^{′} ) ∈ {R}_{Q}^{k + 1} where ( {c}_{0}^{′} = {u}_{0} + ( {𝔤}^{- 1} ( v ) , {d}_{i , 1} 〉 ) , {c}_{i}^{′} = {u}_{i} + ( {𝔤}^{- 1} ( v ) , {d}_{i , 2} 〉 , and {c}_{j}^{′} = {u}_{j} for j ∈ [ k ] ∖ \{ i \} .$$

This c̅ satisfies [symbol] c̅, z̅ [symbol] =θ· [symbol] ĉ, z̅ [symbol] +e′ with the variance of the noise term e′, denoted

$${σ}_{hp}^{2} ,$$

satisfying

$${σ}_{hp}^{2} \leq {kd}_{hp} {N}^{2} {V}_{hp} {σ}_{β}^{2} .$$

Finally, it returns ĉ.

Next, ACC is updated by adding

$$( ⌊ \frac{Q}{8} ⌋ , 0 ) .$$

Subsequently, c̅t̅′̅ is obtained by applying Extract(ACC) to get an element in

$${ℤ}_{Q}^{kN + 1} .$$

Then, the KeySwitch algorithm is performed. The KeySwitch (c̅t̅′̅, {lsksⱼ}_{j∈[k]}) works as follows: Given a MK-LWE ciphertext

$$\overline{ct} = ( b , {a}_{1} , … , {a}_{k} ) ∈ {ℤ}_{q}^{kn + 1} where {a}_{j} = ( {a}_{0 , j} , … , {a}_{n - 1 , j} ) ∈ {ℤ}_{q}^{n}$$

and a set of key-switch keys {lsksⱼ}_{j∈[k]}. For 1≤j≤k, it computes

$$( {b}_{j}^{′} , {a}_{j}^{′} ) = {\sum }_{i = 0}^{N - 1} {𝔤}^{- 1} ( {a}_{i , j} ) \cdot {lsks}_{j} .$$

Then it outputs the ciphertext

$$\overline{{ct}^{′}} = ( b + {\sum }_{i = 1}^{k} {b}_{i}^{′} , {a}_{1}^{′} , … , {a}_{k}^{′} ) .$$

after Extract, KeySwitch is performed on c̅t̅′̅ with {lsksⱼ}_{j∈[k]} to get an element in

$${ℤ}_{Q}^{kn + 1} .$$

Finally, the ModSwitch algorithm is applied. The ModSwitch(c) algorithm: Given a MK-LWE ciphertext

$$c = ( {c}_{0} , … , {c}_{kn} ) ∈ {ℤ}_{Q}^{kn + 1} ,$$

using the randomized rounding function [·]_{q:Q}: [symbol] _{Q}→ [symbol] defined as [x]_{q:Q}=└qx/Q┘+B, it outputs the ciphertext

$${c}^{′} = {( {[ {c}_{i} ]}_{q : Q} )}_{0 \leq i \leq kn} ∈ {ℤ}_{q}^{kn + 1} .$$

After KeySwitch, ModSwitch is applied to c̅t̅′̅ to obtain the result in

$${ℤ}_{q}^{kn + 1} .$$

Decrypts a multi-key ciphertext using all participants' secret keys. Given a MK-LWE ciphertext

$$\overline{ct} = ( {\sum }_{j = 1}^{k} {b}_{j} , {a}_{1} , … , {a}_{k} ) ∈ {ℤ}_{q}^{kn + 1}$$

and secret key s̅=(s₁, . . . . sₖ), compute

$$m = ⌊ \frac{2}{q} ( 〈 \overline{ct} , ( 1 , \overline{s} ) 〉 ) ⌉ ∈ \{ 0 , 1 \} .$$

The principle of the technical schemes is further detailed below.

The LWE Assumption: Let n,q be positive integers, and let χ be a distribution over [symbol] . The decisional LWE_{n,q,χ} problem is to distinguish the following two distributions: In the first distribution, one samples (a, b) uniformly from

$${ℤ}_{q}^{n} \times ℤ .$$

In the second distribution, one first samples

$$a ← {ℤ}_{q}^{n}$$

uniformly and then draws a noise term e←χ, outputting (a, b=a·s+e), where s is drawn from some key distribution over [symbol] .

The decisional LWE_{n,q,χ} assumption says that it is hard for any PPT algorithms to solve decisional LWE_{n,q,χ} with non-negligible advantage over a random guess.

The RLWE Assumption: Let N, Q be positive integers, and let R_{Q}= [symbol] _{Q[X]/(X}^{N}+1). Let R=∩[X]/(X^{N}+1) and χ be a distribution over R. The decisional RLWE_{N,Q,χ} problem is to distinguish the following two distributions: In the first distribution, one samples (a, b) uniformly from R_{Q}×R_{Q}. In the second distribution, one first samples a←R_{Q} uniformly and then draws a noise term e←χ, outputting (a, b=a·s+e), where s is drawn from some key distribution over R.

The decisional RLWE_{N,Q,χ} assumption says that it is hard for any PPT algorithms to solve decisional RLWE_{N,Q,χ} with non-negligible advantage over a random guess.

The NTRU Assumption: Let N, Q, d be positive integers, and let R_{Q}= [symbol] _{Q}[X]/(X^{N}+1) and R= [symbol] [X]/(X^{N}+1). Let χₛ and χₑ be the key and noise distributions over R, respectively. The decisional NTRU_{N,Q,}_{_{χs,χe}} problem is to distinguish the following two distributions:

$$- \{ ( {g}_{0} / f , … , {g}_{d - 1} / f ) \vert f ← {χ}_{s} , {g}_{0} , … , {g}_{d - 1} ← {χ}_{e} \} , \\ - \{ ( {u}_{1} , … , {u}_{d} ) \vert {u}_{1} , … , {u}_{d} ← {R}_{Q} \} .$$

The decisional NTRU assumption (in the vector form) says that it is hard for any PPT algorithms to solve decisional NTRU_{N,Q,}_{_{χs,χe}} with non-negligible advantage over a random guess.

The KDM-form NTRU Assumption: For positive integers N, Q, let R_{Q}= [symbol] _{Q}[X]/(X^{N}+1) and R= [symbol] [X]/(X^{N}+1). Let χₛ and χₑ be the key and noise distributions over R, respectively. For an arbitrarily chosen m ∈ R_{Q} and integers B, d, the decisional KDM-form NTRU_{N,Q}_{_{χs,χe}} problem is to distinguish the following two distributions:

$$- \{ ( ( {g}_{0} + {B}^{0} \cdot m ) / f , … , ( {g}_{d - 1} + {B}^{d - 1} \cdot m ) / f ) \vert f ← {χ}_{s} , {g}_{0} , … , {g}_{d - 1} ← {χ}_{e} \} , \\ - \{ ( {u}_{1} , … , {u}_{d} ) \vert {u}_{1} , … , {u}_{d} ← {R}_{Q} \} .$$

The decisional KDM-form NTRU_{N,Q,}_{_{χs,χe}} assumption says that it is hard for any PPT algorithms to solve decisional KDM-form NTRU_{N,Q}_{_{χs,χe}} with non-negligible advantage over a random guess.

### Gadget Decomposition

For integers q and B, set d=┌log_{B}q┐, the gadget vector [symbol] _{q,B} is define as

$$[ {B}^{0} , … , {B}^{d} - 1 ] ∈ {ℤ}_{q}^{d} .$$

When q and B are clear from the context, we write [symbol] .

For any a ∈ [symbol] _{q}, its gadget decomposition result in base B is define as [symbol] ⁻¹(a)=(a₀, . . . , aₗ₋₁) for each integer

$${a}_{i} ∈ ( - \frac{B}{2} , \frac{B}{2} ]$$

such that tor i ∈ [l]. It is easy to see that [symbol] ⁻¹(a)·g=a. For any ƒ ∈ R_{Q}, we define

$${𝔤}^{- 1} ( f ) := {\sum }_{i = 0}^{N - 1} {𝔤}^{- 1} ( {f}_{i} ) {X}^{i} .$$

It is clear that

$${𝔤}^{- 1} ( f ) \cdot 𝔤 = {\sum }_{i = 0}^{N - 1} {𝔤}^{- 1} ( {f}_{i} ) \cdot 𝔤 \cdot {X}^{i} = {\sum }_{i = 0}^{N - 1} {f}_{i} \cdot {X}^{i} = f$$

The gadget decomposition function [symbol] ⁻¹, which maps a ring element into its digit representation with respect to a fixed gadget basis, can be implemented in either a deterministic or a randomized manner. In this disclosure, we adopt the deterministic variant, as it provides consistent outputs and simplifies correctness analysis in subsequent cryptographic constructions.

### NTRU-Based GSW-Like Encryption

Building upon the concept of gadget decomposition described in the previous subsection, we now turn to an encryption scheme that leverages this structure in a homomorphic setting.

Definition 1 (scalar NTRU ciphertexts). Our scalar NTRU encryption of u ∈ R_{Q} under a secret keyf ∈ R_{Q} (that is invertible in R_{Q}) is defined as:

$${NTRU}_{Q , f} ( u ) = g / f + u / f ∈ {R}_{Q}$$

where both f, g ∈ R_{Q} are polynomials with small coefficients, which are usually taken from a ternary distribution in practice. Note that we don't multiple Δ to u in scalar NTRU encaryption different from [XZD⁺23](g/ƒ+Δ·u/ƒ), which is important for us to ensure the correctness of multi-key bootstrapping.

Definition 2 (vector NTRU ciphertexts). Let [symbol] =(B⁰, B¹, . . . , B^{d-1}) be a gadget vertor, our vector NTRU encryption of v ∈ R_{Q} under a secret key f ∈ R_{Q} (that is invertible in R_{Q}) is defined as:

$${NTRU}_{Q , f}^{′} ( v ) = g / f + v \cdot 𝔤 ∈ {R}_{Q}^{d}$$

where g are noise vector with small coefficients, and d=┌log_{B}Q┐. The external product ⊙:

$${R}_{Q} \times {R}_{Q}^{d} \to {R}_{Q}$$

between scalar NTRU ciphertexts c=NTRU_{Qf}(u) and vector NTRU ciphertexts

$$c = {NTRU}_{Q , f}^{′} ( v )$$

is define as:

$${NTRU}_{Q , f} ( u ) ⊙ {NTRU}_{Q , f}^{′} ( v ) = {𝔤}^{- 1} ( c ) \cdot c$$

Lemma 3: External Product. Let c=NTRU_{Q,f}(u) ∈R_{Q} with noise variance Var(g), and

$$c = {NTRU}_{Q , f}^{′} ( v ) ∈ {R}_{Q}^{d}$$

with noise variance Var(g′). We have that ĉ= [symbol] ⁻¹(c)·c=ĝ/f+u·v/f is a scalar NTRU ciphertexts for uv, and the variance of ĝ satisfies:

$$Var ( \hat{g} ) \leq {dNV}_{B} Var ( {g}^{′} ) + {\vert v \vert}_{2}^{2} \cdot Var ( g )$$

where V_{B} denotes the variance of [symbol] ⁻¹(a) for every a ∈ R_{Q}. In particular, if v is a monomial with binary coefficient, then we have

$$Var ( \hat{g} ) \leq {dNV}_{B} Var ( {g}^{′} ) + Var ( g ) .$$

The NTRU-based GSW-like encryption framework offers a compact and efficient mechanism for encoding both scalar and vector messages in a homomorphic context. Its carefully bounded noise growth, especially under external product operations, is critical for enabling deeper circuit evaluations without compromising correctness. This structure forms the cryptographic backbone of our blind rotation mechanism. In the next section, we leverage these components to construct a single-key blind rotation procedure, which serves as the foundational layer of our full multi-key bootstrapping pipeline.

### Multi-key Fully Homomorphic Encryption

A multi-key fully homomorphic encryption (MK-FHE) scheme is composed of five probabilistic PPT algorithms: Setup, KeyGen, Enc, Dec, and NAND.
Setup (1^{λ}): Takes the security parameter λ, and returns a public parameter set pp.
KeyGen (pp): Outputs a public key pk and secret key sk. Generates and outputs a public/secret key pair (pk, sk).
Enc (m, pk): On input of a bit m ∈ {0,1} and public key pk, outputs a ciphertext ct ∈ {0,1}^{*}. Each ciphertext is assumed to carry metadata indicating the identities of associated parties.
Dec (c̅t̅, {skᵢ}_{i∈[k]}): Given a ciphertext c̅t̅ and a set of secret keys {skᵢ}_{i∈[k]} corresponding to the involved users, returns a decrypted bit m ∈ {0,1}.
NAND (c̅t̅₁, c̅t̅₂, {pkᵢ}_{i∈[k]}): On input of two ciphertexts c̅t̅₁ and c̅t̅₂, along with the public keys pkᵢ of k participating parties (those associated with either input ciphertext), performs a NAND operation and outputs a new ciphertext. c̅t̅ encoding the result. The output ciphertext implicitly contains the indices of the relevant users.

We adopt an extended form of (R)LWE-based encryption adapted for multi-key scenarios.

In the LWE case, for a message m ∈ Zₜ and k secret keys s₁, . . . , sₖ ∈ [symbol] ⁿ, define

$$\overline{ct} = ( b , {a}_{1} , … , {a}_{k} ) ∈ {ℤ}_{q}^{kn + 1} and \overline{s} = ( {s}_{1} , … , {s}_{k} ) ∈ {ℤ}_{q}^{kn} .$$

If the following holds:

$$〈 \overline{ct} , ( 1 , \overline{s} ) 〉 = ⌊ \frac{q}{t} ⌉ \cdot m + e ∈ {ℤ}_{q} ,$$

then c̅t̅ is said to be a MK-LWE ciphertext encrypting m under the concatenated secret key s̅, with error term e.

In the RLWE case, for a message μ∈R_{q} and secre−keys z₁, . . . , zₖ ∈ R, define

$$\overline{c} = ( {c}_{0} , … , {c}_{k} ) ∈ {R}_{Q}^{k + 1} and \overline{z} = ( 1 , {z}_{1} , … , {z}_{k} ) ∈ {R}_{Q}^{k + 1} .$$

### If

$$〈 \overline{c} , \overline{z} 〉 = μ + {e}^{′} ∈ {R}_{Q} ,$$

then c̅ is a MK-RLWE ciphertext representing encryption of μ under the combined secret key z̅, with noise e′.

### Multi-key Bootstrapping Supporting Parallelization

In the previous section, we introduced the fundamental building blocks of our construction, including multi-key FHE, gadget decomposition, and NTRU-based GSW-like encryption. With these tools in place, we now present our complete bootstrapping framework that supports multi-party computation and parallel homomorphic evaluation.

This chapter details the design of our multi-key bootstrapping procedure. We begin by describing a single-key blind rotation algorithm, which serves as the basis for manipulating encrypted data in the Fourier domain. We then extend this to the multi-key setting through ciphertext merging and transformation operations. Finally, we integrate all components into a unified multi-key bootstrapping algorithm that enables ciphertext refresh under multiple keys without compromising correctness or efficiency.

### Single-key Blind Rotation

We design the single-key blind rotation algorithm to output a NTRU encrytion of

$${X}^{\frac{2 N}{q} {\sum }_{i = 0}^{n - 1} {a}_{i} {s}_{i}} .$$

BRKGen(s,f): Given a secret key

$$s = ( {s}_{0} , … , {s}_{n - 1} ) ∈ {ℤ}_{q}^{n}$$

for the first-layer LWE encryption, and a secret key θ ∈ R_{Q} for the second-layer NTRU-based GSWlike encryption, the algorithm first computes a set of ciphertexts:

$${evk}_{0} = {NTRU}_{Q , f}^{′} ( {s}_{0} / f ) , {evk}_{i} = {NTRU}_{Q , f}^{′} ( {s}_{i} ) for 1 \leq i < n .$$

Then, the algorithm outputs EVK=(evk₀, . . . , evkₙ) as the evaluation key for blind rotation.

BREval ((b, a), EVK): Given an LWE-based ciphertext

$${LWE}_{q , s} ( m ) = ( b , a ) ∈ {ℤ}_{q}^{n} \times {ℤ}_{q} ,$$

and an evaluation key EVK at inputs, computes and returns ACC as described in algorithm 1. The algorithm output a NTRU encrytion of

$${X}^{\frac{2 N}{q} {\sum }_{i = 0}^{n - 1} {a}_{i} {s}_{i}} .$$

Algorithm 1 BREval((b, a), EVK)

```
Input:
  $An LWE ciphertext {LWE}_{s , q} ( m ) = ( b , a = ( {a}_{0} , … , {a}_{n - 1} ) ) ∈ {ℤ}_{Q}^{n + 1}$
  An evaluation key EVK = (evk₀, ... , evkₙ)
Output:
  $A NTRU ciphertext {NTRU}_{Q , f} ( {X}^{\frac{2 N}{q} {\sum }_{i = 0}^{n - 1} {a}_{i} {s}_{i}} )$
    1. for i = 0 to n − 1 do
    2.  ${a}_{i}^{′} = \frac{2 N}{q} {a}_{i}$
    3. end for
    4.  $ACC ← {X}^{{a}_{o}^{′}} ⊙ {evk}_{0}$
    5. for i = 1 to n − 1 do
    6.  $ACC ← ACC ⊙ [ 𝔤 + ( {X}^{{a}_{i}^{′}} - 1 ) \cdot {evk}_{i} ]$
    7. end for
    8. return ACC
```

Lemma 4 (Single-key Blind Rotation): Let LWE-based ciphertext

$${LWE}_{q , s} ( m ) = ( b , a ) ∈ {ℤ}_{q}^{n} \times {ℤ}_{q}$$

under secret key s̅ ∈

$${ℤ}_{q}^{n} , where a = ( {a}_{0} , … , {a}_{n - 1} ) ∈ {ℤ}_{q}^{n} .$$

Let N be a power of 2 and q|N. Let f ∈ R_{Q} be a polynomial that is invertible in R_{Q}. Then for any EVK=BRKGen(s,f), we have that

$$BREval ( ( b , a ) , EVK ) = NTRU ( {X}^{\frac{2 N}{q} {\sum }_{i = 0}^{n - 1} {a}_{i} {s}_{i}} ) = \hat{g} / f + {X}^{\frac{2 N}{q} {\sum }_{i = 0}^{n - 1} {a}_{i} {s}_{i}} / f .$$

The variance of ĝ satisfies

$$Var ( \hat{g} ) \leq ( 2 n - 1 ) {dNV}_{B} {σ}_{e}^{2} , where {σ}_{e}^{2}$$

is the noise variance for the second-layer NTRU encrytion. We denote

$${σ}_{BR}^{2}$$

as the variance of ĝ. We denote

$${σ}_{e}^{2}$$

be the noise variance for the evkᵢ for 0≤i≤n−1. In line 4 of Algorithm 1, We have the value of ACC equals

$${X}^{{a}_{0}^{′}} ⊙ {evk}_{0} = {X}^{{a}_{0}^{′}} ⊙ {NTRU}_{Q , f}^{′} ( {s}_{0} / f ) = {NTRU}_{Q , f} ( {X}^{{a}_{0}^{′} {s}_{0}} )$$

with noise variance

$$d N {V}_{B} {σ}_{e}^{2}$$

by Lemma 3. In line 6, it is easy to see that

$$𝔤 + ( {X}^{{a}_{i}^{′}} - 1 ) \cdot$$

$${evk}_{i} = {NTRU}_{Q , f}^{′} ( {X}^{{a}_{i}^{′} {s}_{i}} )$$

with noise variance bounded by

$${\vert {X}^{{a}_{i}^{′}} - 1 \vert}_{2}^{2} \cdot {σ}_{e}^{2} \leq 2 {σ}_{e}^{2} .$$

Let cᵢ be the value of ACC after evaluating the i-th loop in line 5-7, we have

$$\begin{matrix}{c}_{i} = ACC ⊙ [ 𝔤 + ( {X}^{{a}_{i}^{′}} - 1 ) \cdot {evk}_{i} ] \\ = {NTRU}_{Q , f} ( {X}^{{\sum }_{j = 0}^{i = 1} {a}_{j}^{′} {s}_{j}} ) ⊙ \backslash {omathrmNTRU}_{Q , f}^{′} ( {X}^{{a}_{i}^{′} {s}_{i}} ) \\ = {NTRU}_{Q , f} ( {X}^{{\sum }_{j = 0}^{i} {a}_{j}^{′} {s}_{j}} )\end{matrix} .$$

Based on Lemma 3, the increased noise of each iteration has variance dNV_{B}·2σₑ. After the loop from line 5 to 7, the output ciphertext ACC equals

$$NTRU ( {X}^{\frac{2 N}{q} {\sum }_{i = 0}^{n - 1} {a}_{i} {s}_{i}} )$$

with variance bounded by

$$d N {V}_{B} {σ}_{e}^{2} + ( n - 1 ) d N {V}_{B} \cdot 2 {σ}_{e}^{2} = ( 2 n - 1 ) d N {V}_{B} {σ}_{e}^{2} .$$

### Merge NTRU Ciphertext into MK-RLWE Ciphertext

To support homomorphic multiplication in the multi-key setting, we introduce a new operation that merges a scalar NTRU ciphertext with a multi-key RLWE ciphertext. This operation is crucial for enabling key-consistent evaluations across ciphertexts encrypted under different keys.

We define a two-step multiplication process. First, we outline the construction of the HybridProduct and the associated noise key-switching keys (nksk), which form the foundation for our ciphertext merging mechanism. These components will be integrated into our overall bootstrapping procedure to ensure correct and efficient message multiplication.

HPKGen(zᵢ,θᵢ): Given a RLWE secret key zᵢ ∈ R_{Q} and a NTRU secret key θᵢ ∈ R_{Q} of party i, it generates and returns the hpkᵢ=(d_{i,0}, d_{i,1}, d_{i,2}) as follows:

Sample rᵢ←χ_{σ}_{_{β}} and a noise vector

$${e}_{i , 0} ← {χ}_{{σ}_{β}}^{{d}_{h p}} ,$$

output the vector

$${d}_{i , 0} = {r}_{i} \cdot a + {f}_{i} \cdot 𝔤 + {e}_{i , 0} ∈ {R}_{Q}^{{d}_{h p}} .$$

Sample

$${d}_{i , 1} ← {R}_{Q}^{{d}_{h p}}$$

and a noise vector

$${e}_{i , 1} ← {χ}_{{σ}_{β}}^{{d}_{h p}} ,$$

compute

$${d}_{i , 2} = - {z}_{i} \cdot {d}_{i , 1} + {r}_{i} \cdot 𝔤 + {e}_{i , 1} ∈ {R}_{Q}^{{d}_{h p}}$$

and output(d_{i,1},d_{i,2})

HybridProduct (c̅, hpkᵢ, {bⱼ}_{j∈[k]}): Given an MK-RLWE ciphertext

$$\overline{c} = ( {c}_{0} , … , {c}_{k} ) ∈ {R}_{Q}^{k + 1} , {hpk}_{i} = ( {d}_{i , 0} , {d}_{i , 1} , {d}_{i , 2} )$$

of party i and the public keys {bⱼ}_{j∈[k]} of parties associated with c̅, return an MK-RLWE ciphertext c̅′ as follows: for 0≤j≤k compute

$${u}_{j} = 〈 {𝔤}^{- 1} ( {c}_{j} ) , {d}_{i , 0} 〉 .$$

Then compute

$$v = {\sum }_{j = 0}^{k} 〈 {𝔤}^{- 1} ( {c}_{j} ) , {b}_{j} 〉 ,$$

return an MK-RLWE ciphertext

$${\overline{c}}^{′} = ( {c}_{0}^{′} , {c}_{1}^{′} , … , {c}_{k}^{′} ) ∈ {R}_{Q}^{k + 1} ,$$

where

$${c}_{0}^{′} = {u}_{0} + 〈 {𝔤}^{- 1} ( v ) , {d}_{i , 1} 〉 , {c}_{i}^{′} = {u}_{i} + 〈 {𝔤}^{- 1} ( v ) , {d}_{i , 2} 〉 , {c}_{j}^{′} = {u}_{j} for ∈ [ k ] ∖ i .$$

The output ciphertext c̅′̅ satisfies:

$$〈 {\overline{c}}^{′} , \overline{z} 〉 = f \cdot 〈 \overline{c} , \overline{z} 〉 + {e}^{′} .$$

Let

$${σ}_{hp}^{2}$$

denotes the vanance or me noise term e′, we have

$${σ}_{hp}^{2} \leq {kd}_{hp} {N}^{2} {V}_{hp} {σ}_{β}^{2} .$$

Algorithm 2 Merge(c, c̅, NKSKᵢ, hpkᵢ, {bⱼ}_{j∈[k]})

```
Input:
A scalar NTRU ciphertext (NTRU_{f}_{ᵢ}_{,Q}(m) = c ∈ R_{Q})
$A Multi ‐ Key RLWE ciphertext \overline{c} = ( {c}_{0} , {c}_{1} , … , {c}_{k} ) ∈ {R}_{Q}^{k + 1}$
Product Key (NKSKᵢ = {nkskⱼ}_{0≤j≤d-1}, hpkᵢ, {bⱼ}_{j∈[k]})
Output:
$A Multi ‐ Key RLWE ciphertext {\overline{c}}^{′} = ( {c}_{0}^{′} , {c}_{1}^{′} , … , {c}_{k}^{′} ) ∈ {R}_{Q}^{k + 1}$
  1. for j = 0 to d − 1 do
  2. vⱼ = c ⊙ nkskⱼ
  3. end for
  4. v = (v₀, v₁, .... , v_{d-1})
  5. for j = 0 to k do
  6. cⱼ′ = g⁻¹ (cⱼ) · v (mod Q)
  7. end for
  8.   $\hat{c} = ( {c}_{0}^{′} , {c}_{1}^{′} , … , {c}_{k}^{′} )$
  9.  c̅′̅ ← HybridProduct (ĉ, hpkᵢ, {bⱼ}_{j∈[k]})
10. return ĉ
```

NKSKGen(ƒ,B): Given a NTRU secret key ƒ and gadget base B, the algorithm compute a set of ciphertexts

$${nksk}_{i} = {NTRU}_{f , Q}^{′} ( {B}^{i} ) ∈ {R}_{Q}^{d}$$

for 0≤i≤d−1 and return NKSK={nkskᵢ}_{0≤i≤d-1}.

Correctness of Algorithm 2: We show that if NTRU_{θ}_{ᵢ}_{, Q}(m)=c is a scalar NTRU ciphertext that encrypts m under secret key ƒᵢ and c̅=(c₀, c₁, . . . , cₖ) is a MK-RLWE ciphertext that encrypts uunder secret key z̅=(z₀, z₁, . . . , zₖ), then the output ciphertext c̅′̅ is a MK-RLWE ciphertext that encrypts m·μ.

The algorithm first compute vᵢ for (0≤i≤d−1) in line 1-2, we have

$$( {v}_{j} = c ⊙ {nksk}_{j} = {NTRU}_{{f}_{i} , Q} ( m ) ⊙ {NTRU}_{{f}_{i} , Q}^{′} ( {B}^{i} ) = {NTRU}_{{f}_{i} , Q} ( m \cdot {B}^{j} ) ) .$$

Then in line 4, we have

$$v = ( {v}_{0} , {v}_{1} , … , {v}_{d - 1} ) = ( \frac{{g}_{0}^{′}}{{f}_{i}} + {B}^{0} \cdot \frac{m}{{f}_{i}} , … , \frac{{g}_{d - 1}^{′}}{{f}_{i}} + {B}^{d - 1} \cdot \frac{m}{{f}_{i}} ) = \frac{{g}^{′}}{{f}_{i}} + \frac{m \cdot 𝔤}{{f}_{i}} ∈ {R}_{Q}^{d}$$

where

$${g}^{′} = ( {g}_{0}^{′} , … , {g}_{d - 1}^{′} ) ∈ {R}_{Q}^{d} and {\{ {g}_{j}^{′} \}}_{j ∈ [ d ]}$$

are noise polynomials with small coefficients. Then the algorithm compute

$$( {c}_{j}^{′} = {𝔤}^{- 1} ( {c}_{j} ) \cdot v ∼ ( mod Q ) = \frac{{𝔤}^{- 1} ( {c}_{j} ) \cdot {g}^{′}}{{f}_{i}} + \frac{{c}_{j} \cdot m}{{f}_{i}} )$$

for 0≤j≤d−1) Let

$$\hat{c} = ( {c}_{0}^{′} , {c}_{1}^{′} , … , {c}_{k}^{′} ) ,$$

we have that

$$\hat{c} = ( {c}_{0}^{′} , {c}_{1}^{′} , … , {c}_{k}^{′} ) = ( \frac{{𝔤}^{- 1} ( {c}_{0} ) \cdot {g}^{′}}{{f}_{i}} + \frac{{c}_{0} \cdot m}{{f}_{i}} , … , \frac{{𝔤}^{- 1} ( {c}_{k} ) \cdot {g}^{′}}{{f}_{i}} + \frac{{c}_{k} \cdot m}{{f}_{i}} ) ∈ {R}_{Q}^{k + 1} .$$

After HybridProduct in line 9, we finally have the output ciphertext c̅′̅ satisfies that

$$〈 {\overline{c}}^{′} , \overline{z} 〉 \approx {f}_{i} \cdot 〈 \hat{c} , \overline{z} 〉 = 〈 {f}_{i} \cdot \hat{c} , \overline{z} 〉 \approx 〈 m \cdot \overline{c} , \overline{z} 〉 = m \cdot 〈 \overline{c} , \overline{z} 〉 \approx m \cdot μ .$$

So c̅′̅ is a MK-RLWE ciphertext that encrypts m·μ.

### Lemma 5 (Merge)

Let NTRU_{ƒ}_{ᵢ}_{,Q}(m)=c be a scalar NTRU ciphertext that encrypts m under secret key ƒᵢ. Let c̅=(c₀, c₁, . . . , cₖ) be a MK-RLWE ciphertext under secret key z̅=(z₀, z₁, . . . , zₖ). The output ciphertext c̅′ of Algorithm 2 is a MK-RLWE ciphertext such that [symbol] c̅′, z̅ [symbol] =m· [symbol] c̅, z̅ [symbol] +e′ for some noise term e′ ∈ R_{Q}. Let

$${σ}_{p d}^{2}$$

be the variance of noise term e′, we have that

$${σ}_{p d}^{2} \leq ( 1 + kN / 2 ) ( {d}^{2} {N}^{2} {V}_{B}^{2} {σ}_{e}^{2} + d N {V}_{B} Var ( g ) ) + k {d}_{h p} {N}^{2} {V}_{h p} {σ}_{β}^{2} .$$

where

$$Var ( g ) , {σ}_{e}^{2}$$

are the noise vanance of c and the noise variance of nksk, respectively.

By definition, we have c=g/ƒᵢ+m/ƒᵢ=NTRU_{ƒ}_{ᵢ}_{,Q}(m) ∈ R_{Q} with noise polynomial g, and

$${nksk}_{j} = {NTRU}_{f , Q}^{′} ( {B}^{j} ) ∈ {R}_{Q}^{d}$$

with noise variance

$${σ}_{e}^{2} .$$

The algorithm first compute vⱼ for (0≤j≤d−1) in line 1-2, we have that

$${v}_{j} = c ⊙ {nksk}_{j} = {NTRU}_{{f}_{i} , Q} ( m ) ⊙ {NTRU}_{{f}_{i} , Q}^{′} ( {B}^{i} ) = \frac{{g}_{j}^{′}}{{f}_{i}} + {B}^{j} \cdot \frac{m}{{f}_{i}}$$

where

$$Var ( {g}_{j}^{′} ) \leq d N {V}_{B} {σ}_{e}^{2} + Var ( g )$$

by lemma 3.

Then in line 4, we have

$$v = ( {v}_{0} , {v}_{1} , … , {v}_{d - 1} ) = ( \frac{{g}_{0}^{′}}{{f}_{i}} + {B}^{0} \cdot \frac{m}{{f}_{i}} , … , \frac{{g}_{d - 1}^{′}}{{f}_{i}} + {B}^{d - 1} \cdot \frac{m}{{f}_{i}} ) = \frac{{g}^{′}}{{f}_{i}} + \frac{m \cdot 𝔤}{{f}_{i}} ∈ {R}_{Q}^{d}$$

where

$${g}^{′} = ( {g}_{0}^{′} , … , {g}_{d - 1}^{′} ) ∈ {R}_{Q}^{d} .$$

Then the algorithm compute

$${c}_{j}^{′} = {𝔤}^{- 1} ( {c}_{j} ) \cdot v ∼ ( mod Q ) = {𝔤}^{- 1} ( {c}_{j} ) \cdot {g}^{′} / {f}_{i} + {c}_{j} \cdot m / {f}_{i} ) for ( 0 \leq j \leq d - 1 ) .$$

Let

$$\hat{c} = ( {c}_{0}^{′} , {c}_{1}^{′} , … , {c}_{k}^{′} ) ,$$

we have that

$$\hat{c} = ( {c}_{0}^{′} , {c}_{1}^{′} , … , {c}_{k}^{′} ) = ( \frac{{𝔤}^{- 1} ( {c}_{0} ) \cdot {g}^{′}}{{f}_{i}} + \frac{{c}_{0} \cdot m}{{f}_{i}} , … , \frac{{𝔤}^{- 1} ( {c}_{k} ) \cdot {g}^{′}}{{f}_{i}} + \frac{{c}_{k} \cdot m}{{f}_{i}} ) ∈ {R}_{Q}^{k + 1} .$$

Let ĝ=( [symbol] ⁻¹(c₀)·g′, . . . , [symbol] ⁻¹(cₖ)·g′),the variance Var(ĝ) of ĝ satisfies

$$Var ( \hat{g} ) = d N {V}_{B} Var ( {g}^{′} ) \leq {d}^{2} {N}^{2} {V}_{B}^{2} {σ}_{e}^{2} + d N {V}_{B} Var ( g ) .$$

Let e″ be the noise introduced by the HybridProduct with variance

$$Var ( {e}^{″} ) \leq k {d}_{h p} {N}^{2} {V}_{h p} {σ}_{β}^{2} .$$

After HybridProduct in line 9, we finally have the output ciphertext c̅′̅ satisfies that

$$〈 \overline{{c}^{′}} , \overline{z} 〉 = {f}_{i} 〈 \hat{c} , \overline{z} 〉 + {e}^{″} = 〈 ( \hat{g} + \overline{c} \cdot m ) , \overline{z} 〉 + {e}^{″} = 〈 \hat{g} , \overline{z} 〉 + m \cdot 〈 \overline{c} , \overline{z} 〉 + {e}^{″} = m \cdot 〈 \overline{c} , \overline{z} 〉 + {e}^{′}$$

where e′= [symbol] ĝ,z̅ [symbol] +e″. We denote

$${σ}_{p d}^{2}$$

as the variance of e′, it is bounded by

$${σ}_{p a d}^{2} = ( 1 + kN / 2 ) Var ( \tilde{g} ) + Var ( {e}^{″} ) \leq ( 1 + KN / 2 ) ( {d}^{2} {N}^{2} {V}_{B}^{2} {σ}_{e}^{2} + d N {V}_{BVar} ( g ) ) + k {d}_{h p} {N}^{2} {V}_{h p} {σ}_{β}^{2} .$$

### The Multi-key Bootstrapping Algorithm

We first define the LWE-based Multi-key modswitch and multi-key keyswitch that will used in Multi-key Bootstrapping as follows.

LKSKGen (z,s): Given two LWE secret key z=(z₀, . . . , z_{N-1}) ∈ [symbol] ^{N} and s=(s₀, . . . , s_{N-1}) ∈\ [symbol] ⁿ, sample

$${A}_{i} ← {ℤ}_{q}^{d \times n}$$

and noise

$${e}_{i} ← {χ}_{{σ}_{α}}^{d}$$

for 0≤i≤N−1, then compute

$${b}_{i} = - {A}_{i} \cdot s + {e}_{i} + {z}_{i} \cdot 𝔤 ∈ {Z}_{q}^{d} .$$

and output the key-swithch key lksk={(bᵢ,Aᵢ)}_{0≤j≤N-1}.

KeySwitch(c̅t̅,{lkskⱼ}_{j∈[k]}): Given a MK-LWE ciphertext

$$\overline{c t} = ( b , {a}_{1} , … , {a}_{k} ) ∈ {Z}_{q}^{kn + 1} for {a}_{j} = ( {a}_{0 , j} , … , {a}_{n - 1 , j} ) ∈ {ℤ}_{q}^{n} ,$$

and a set of key-switch key {lkskⱼ}_{j∈[k]}. For 1≤j≤k, the algorithm compute

$$( {b}_{j}^{′} , {a}_{j}^{′} ) = {\sum }_{i = 0}^{N - 1} {fg}^{- 1} ( {a}_{i , j} ) \cdot {lksk}_{j} .$$

Then output the ciphertext

$$\overline{{ct}^{′}} = ( b + {\sum }_{i = 1}^{k} {b}^{′} , {a}_{1}^{′} , … , {a}_{k}^{′} ) .$$

Lemma 6 (Key Switching for MK-LWE): Let

$$\overline{ct} = ( b , {a}_{1} , … , {a}_{k} ) ∈ {ℤ}_{q}^{kN + 1}$$

be a MK-LWE ciphertext encrypting m under secret key

$$( 1 , \overline{z} ) ∈ {Z}_{q}^{kN + 1} ,$$

and ${lkskⱼ=LKSKGen(zⱼ,sⱼ)}_{j∈[k]}$ be a set of key-swithcing key. The output ciphertext

$$\overline{{ct}^{′}} = KeySwitch ( \overline{ct} , {\{ {lksk}_{j} \}}_{j ∈ [ k ]} ) ∈ {ℤ}_{q}^{kn + 1}$$

is a ciphertext that encrypts m under secret key

$$( 1 , \overline{s} ) ∈ {Z}_{q}^{kn + 1} .$$

Moreover, the increased noise e′ has variance

$${σ}_{ks}^{2} \leq {kdNV}_{ks} {σ}_{α}^{2} .$$

At the last step of our Multi-key bootstrapping, we will need to switch the modulus of an MK-LWE ciphertext, we define the ModSwitch algorithm using randomized rounding function.

ModSwitch(c): Given a MK-LWE ciphertext

$$c = ( {c}_{0} , … , {c}_{kn} ) ∈ {Z}_{Q}^{kn + 1} ,$$

using the randomized rounding function [·]_{Q:q}: [symbol] _{Q}→ [symbol] _{q} defined as [x]_{Q:q}=└qx/Q┘+B, output the ciphertext

$${c}^{′} = {( {[ {c}_{i} ]}_{Q : q} )}_{0 \leq i < kn} ∈ {ℤ}_{q}^{kn + 1}$$

where B ∈ {0,1} is a Bernoulli random variable with Pr{B=1}=(qx/Q)−└qx/Q┘ ∈ [0,1).

Lemma 7 (ModSwitch for MK-LWE): Let

$$c ∈ {ℤ}_{Q}^{kn + 1}$$

is a MK-LWE ciphertext of μ with noise e. Then c′=ModSwitch(c) is a MK-LWE ciphertext of μ in

$${Z}_{q}^{kn + 1} .$$

Moreover, the noise e′ of c′ has variance

$$Var ( {e}^{′} ) \leq \frac{{q}^{2}}{{Q}^{2}} Var ( e ) + {σ}_{MS}^{2} .$$

Algorithm 2 Multi-key Bootstrapping

```
Input:
$A Multi ‐ Key LWE ciphertext \overline{ct} = ( b , {a}_{1} , … , {a}_{k} ) ∈ {ℤ}_{q}^{k n + 1}$
Product Key(({NKSKⱼ}, {hpkⱼ}, {bⱼ})_{j∈[k]})
Evaluation key {EVKⱼ} = {(evk_{0,j}, ... , evk_{n,j})}_{j∈[k]}
LWE key-switching key{lkskⱼ}_{j∈[k]}
Output:
$A Multi ‐ Key LWE ciphertext {\overline{ct}}^{′} ∈ {ℤ}_{q}^{k n + 1}$
  1.  $ACC ← ( - ⌊ \frac{Q}{8} ⌉ \cdot {X}^{\frac{2 N}{q} b} \cdot {\sum }_{\frac{N}{2} < i < \frac{N}{2}} {X}^{i} , 0 ) ∈ {R}_{Q}^{k + 1}$
  2. for j = 1 to k do
  3. ACCⱼ′ ← BREval((b, aⱼ), EVKⱼ)
  4. end for
  5. For j = 1 to k do
  6. ACC ← Merge(ACC, ACCⱼ′, NKSKⱼ, hpkⱼ, {bⱼ}_{j∈[k]})
  7. end for
  8.  $ACC ← ACC + ( ⌊ \frac{Q}{8} ⌉ , 0 )$
  9.  ${\overline{ct}}^{′} ← Extract ( ACC ) ∈ {ℤ}_{Q}^{k N + 1}$
10.  ${\overline{ct}}^{′} ← KeySwitch ( {\overline{ct}}^{′} , {\{ {lksk}_{j} \}}_{j ∈ [ k ]} ) ∈ {ℤ}_{Q}^{k n + 1}$
11.  ${\overline{ct}}^{′} ← ModSwitch ( {\overline{ct}}^{′} ) ∈ {ℤ}_{q}^{k n + 1}$
```

### Correctness of Algorithm 3

Let [symbol] for 1≤j≤k be the value of

$${ACC}_{j}^{′}$$

in line 3, and

$${a}_{j} = ( {a}_{0 , j} , … , {a}_{n - 1 , j} ) ∈ {ℤ}_{q}^{n} , {s}_{j} = ( {s}_{0 , j} , … , {s}_{n - 1 , j} ) ∈ {ℤ}_{q}^{n}$$

for the LWE public key and LWE secret key of party j, by the correctness of single-key blind rotaion we have

$$= {NTRU}_{Q , f} ( {X}^{\frac{2 N}{q} {\sum }_{i = 0}^{n - 1} {a}_{i , j} {s}_{i , j}} ) = {NTRU}_{Q , f} ( {X}^{\frac{2 N}{q} 〈 {a}_{j} , {s}_{j} 〉} ) .$$

Then the algorithm mulitple scalar NTRU ciphertext

$${ACC}_{j}^{′}$$

to the MK-RLWE ciphertext ACC for 1≤j≤k. Let ĉ be the value of ACC after iteration in line 7, we have

$$\begin{matrix}〈 \hat{c} , \overline{z} 〉 \approx ⌊ \frac{Q}{8} ⌉ \cdot {X}^{\frac{2 N}{q} b} \cdot {X}^{\frac{N}{2}} \cdot {{\sum }_{i = 0}}^{N - 1} {X}^{i} \cdot {X}^{\frac{2 N}{q} {\sum }_{j = 1}^{k} 〈 {a}_{j} , {s}_{j} 〉} \\ = ⌊ \frac{Q}{8} ⌉ \cdot {\sum }_{- \frac{N}{2} < i < \frac{N}{2}} {X}^{i} \cdot {X}^{\frac{2 N}{q} ( b + {\sum }_{j = 1}^{k} 〈 {a}_{j} , {s}_{j} 〉 )}\end{matrix} .$$

Let

$$R ( X ) = {\sum }_{- \frac{N}{2} < i < \frac{N}{2}} {X}^{i} \cdot {X}^{\frac{2 N}{q} ( b + {\sum }_{j = 1}^{k} 〈 {a}_{j} , {s}_{j} 〉 )} .$$

### Because

$$b + {\sum }_{j = 1}^{k} 〈 {a}_{j} , {s}_{j} 〉 = 〈 \overline{c} t , ( 1 , \overline{s} ) 〉 \approx \frac{q}{2} m ,$$

if m=0, the constant term of R(X) is approximately equal to 1; otherwise, if m=1 it is approximately equal to −1. Therefore, the constant term of [symbol] ĉ, z̅ [symbol] approximately equal to

$$\$ ⌊ \frac{Q}{4} ⌉ m - ⌊ \frac{Q}{8} ⌉ .$$

In line 8 the algorithm add

$$( ⌊ \frac{Q}{8} ⌉ , 0 )$$

to ACC, so the value of ACC is a MK-RLWE encrytion that the constant trem of plaintext is

$$⌊ \frac{Q}{4} ⌉ m .$$

After that the algorithm extract a MK-LWE ciphertext

$${\overline{c t}}^{′} ∈ {ℤ}_{Q}^{kN + 1} ,$$

which satisfies

$$〈 \overline{c t} , ( 1 , \overline{z} ) 〉 \approx ⌊ \frac{Q}{4} ⌋ m .$$

Then the MKSwitch switch the secret key from z̅ to s̅. Finally after ModSwitch the alogrithm return a the refreshed MK-LWE ciphertext

$${\overline{c t}}^{′} ∈ {ℤ}_{q}^{kn + 1} .$$

### Lemma 8 (Multi-key Boostrapping)

Let

$${\overline{c t}}^{′} = ( b , {a}_{1} , … , {a}_{k} ) ∈ {Z}_{q}^{kn + 1}$$

be a MK-LWE ciphertext encryping a plaintext m under secret key (1,s̅). The output ciphertext c̅t̅′̅ of Algorithm 3 is an refreshed MK-LWE ciphertext encryping the same plaintext $m$. In addition, the noise e of refreshed ciphertext has variance

$$Var ( e ) \leq \frac{{q}^{2}}{{Q}^{2}} ( k {σ}_{pd}^{2} + {σ}_{ks}^{2} ) + {σ}_{MS}^{2}$$

where

$${σ}_{pd}^{2} , {σ}_{lks}^{2} , {σ}_{MS}^{2}$$

are ine noise variances contributed respectively by the product, the keyswitch, and the modswitch in Algorithm 3.

Initially, the algorithm set ACC as the trivial MK-RLWE encryption with no noise. Let [symbol] for 1≤j≤k be the value of ACC′ⱼ in line 3. By lemma 4 we have that the noise [symbol] of [symbol] has variance

$$Var ( {\hat{e}}_{j} ) = {σ}_{BR}^{2} \leq ( 2 n + 1 ) {dNV}_{B} {σ}_{e}^{2} .$$

Then after multiplying ACC′ⱼ to ACC k times (line 5-7), by lemma 5 we have that the noise variance of ACC is bounded by kσ_{pd}², we have

$$k {σ}_{p d}^{2} \leq k ( 1 + kN / 2 ) ( {d}^{2} {N}^{2} {V}_{B}^{2} {σ}_{e}^{2} + dkN {V}_{B} {σ}_{B R}^{2} ) + {k}^{2} {d}_{h p} {N}^{2} {V}_{h p} {σ}_{β}^{2} = ( 2 + kN / 2 + 2 n ) ( k {d}^{2} {N}^{2} {V}_{B}^{2} {σ}_{e}^{2} ) + {k}^{2} {d}_{h p} {N}^{2} {V}_{h p} {σ}_{β}^{2} .$$

By a trivial Extract in line 9, we get an MK-LWE ciphertext c̅t̅′̅ without increasing the noise variance. After KeySwitch in line 10, by lemma 6 we have that the noise varince of c̅t̅′̅ is bounded by

$${k}^{2} {σ}_{p d} + {σ}_{k s}^{2} .$$

Then by lemma 7 the noise vatince after ModSwitch is bounded by

$$\frac{{q}^{2}}{{Q}^{2}} ( k {σ}_{pd}^{2} + {σ}_{k s}^{2} ) + {σ}_{M S}^{2} .$$

We finally have the output ciphertext c̅t̅′̅ has noise variance

$$\begin{matrix}Var ( e ) \leq \frac{{q}^{2}}{{Q}^{2}} ( k {σ}_{p d}^{2} + {σ}_{k s}^{2} ) + {σ}_{M S}^{2} \\ = \frac{{q}^{2}}{{Q}^{2}} ( ( 2 + kN / 2 + 2 n ) ( k {d}^{2} {N}^{2} {V}_{B}^{2} {σ}_{e}^{2} + {k}^{2} {d}_{h p} {N}^{2} {V}_{h p} {σ}_{β}^{2} ) \\ + {kdNV}_{k s} {σ}_{α}^{2} ) + {σ}_{M S}^{2}\end{matrix}$$

### Multi-key FHE Scheme

In this section, we explicitly describe an MKHE scheme based on all building blocks.

MKHE.Setup (1^{λ}):
Run LWE.Setup (1⁸⁰ ) to generate the parameter pp^{LWE}=(n, χ, σ_{α}, B, d, q).
Run RLWE.Setup (1^{λ}) to generate the parameter pp^{RLWE}=(N, χ, σ_{β}, B, d, a, Q).
Run NTRU.Setup (1^{λ}) to generate the parameter pp^{NTRU}=(N, χ, σₑ, B, d, Q).
Return the generated public parameters pp^{MKHE}=(pp^{LWE}, pp^{RLWE}, pp^{NTRU}).

MKHE.KeyGen( ): Each party i independently generates its keys as follows.
Sample an LWE secret key

$${s}_{i} = ( {s}_{i , 0} , … , {s}_{i , n - 1} ) ∈ {Z}_{q}^{n}$$

Sample a RLWE secret key zᵢ ∈ R_{Q}, a noise vector

$${e}_{i} ← {𝒳}_{{σ}_{β}}^{d}$$

and compute

$${b}_{i} = - a \cdot {z}_{i} + {e}_{i} ∈ {R}_{Q}^{d} .$$

Generate the product key for NTRU product MK-RLWE: hpkᵢ←HPKGen(zᵢ,ƒᵢ),NKSKᵢ←NKSKGen(ƒᵢ,B).
Generate the evaluation key for Single-key blind rotation EVKᵢ←BRKGen(sᵢ,ƒᵢ).
Let zᵢ^{*}=(z_{i,0},−z_{i,N-1}, . . . ,−z_{i,1}) ∈ [symbol] ^{N} for zᵢ=z_{i,0}+z_{i,1}X+. . . +z_{iN-1}X^{N-1}.

Generate the MK-LWE keyswitch key lkskᵢ←LKSKGen(zᵢ^{*},sᵢ).
Publish(bᵢ, hpkᵢ, NKSKᵢ, EVKᵢ, lkskᵢ).

MKHE.Enc(sᵢ,m): Given a plaintext m ∈ 0,1,party i sample

$${a}_{i} ← {ℤ}_{q}^{n} , e ← {𝒳}_{{σ}_{α}}$$

and output a LWE ciphertext

$${c}_{i} = ( - 〈 {a}_{i} , {s}_{i} 〉 + \frac{q}{4} m + e , {a}_{i} ) ∈ {ℤ}_{q} \times {ℤ}_{q}^{n} .$$

MKHE.Expand({cⱼ}_{j∈[k]}): Given

$${c}_{j} = ( {b}_{j} , {a}_{j} ) ∈ {ℤ}_{q}^{n + 1}$$

1≤j≤k, return the MK-LWE ciphertext

$$\overline{ct} = ( {\sum }_{j = 1}^{k} {b}_{j} , {a}_{1} , … , {a}_{k} ) ∈ {ℤ}_{q}^{k n + 1} .$$

MKHE.Dec (c̅t̅, {sⱼ}_{j∈[k]}): Given a MK-LWE ciphertext

$$\overline{ct} = ( {\sum }_{j = 1}^{k} {b}_{j} , {a}_{1} , … , {a}_{k} ) ∈ {ℤ}_{q}^{k n + 1}$$

and secret key s̅=(s₁, . . . sₖ), compute

$$m = ⌊ \frac{2}{q} ( 〈 \overline{ct} , ( 1 , \overline{s} ) 〉 ) ⌉ ∈ \{ 0 , 1 \} .$$

MKHE.NAND(c̅t̅₁, c̅t̅₂): Given two MK-LWE ciphertexts

$${\overline{ct}}_{1} ∈ {ℤ}_{q}^{kn + 1} and {\overline{ct}}_{2} ∈ {ℤ}_{q}^{k n + 1} ,$$

evaluate the NAND gate and refresh the result ciphertext through multi-key bootstapping:
1. Compute

$$\overline{ct} = ( \frac{5 q}{8} , 0 , … , 0 ) - {\overline{ct}}_{1} - {\overline{ct}}_{2} ∈ \backslash {ℤ}_{q}^{k n + 1} .$$

2. Run Multi-key bootstrapping Algorithm 3 to get the refreshed ciphertext c̅t̅′̅,return c̅t̅′̅.

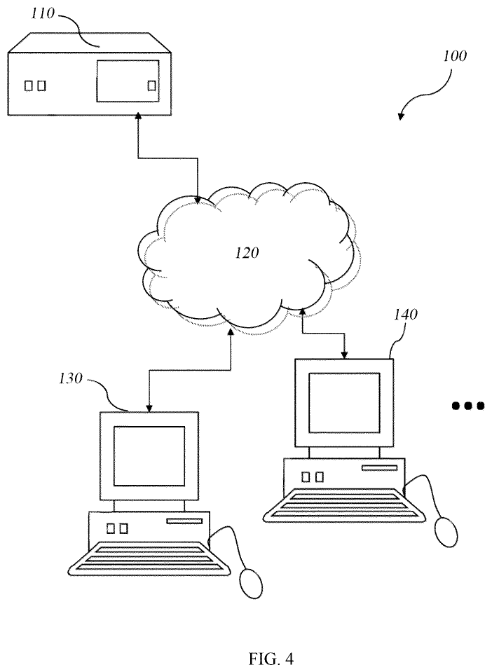

According to another aspect of the present disclosure, as shown in FIG. 4, a computing system 100 is provided. According to some embodiments of the present disclosure, the computing system 100 comprises a central node 110, a network 120, and a plurality of participant nodes 130, 140 implemented on hardware such as cloud servers and edge devices. The central node 110, typically a cloud server (e.g., AWS EC2 instance with 16 GB RAM, 8-core Intel Xeon CPU, and 100 GB SSD storage), produces and disseminates the unified parameter set pp^{LWE}=(n, χ, σ_{α}, B,d, q), pp^{RLWE}=(N, χ, σ_{β}, B,d, a, Q), pp^{NTRU}=(N, χ, σₑ, B,d, Q) including the noise distribution χand gadget base B. The parameters are transmitted over a secure network (e.g., VPN with AES-256 encryption) to participant nodes 130, 140.

Each participant node, implemented on an edge device (e.g., Raspberry Pi 4 with 4 GB RAM, quad-core ARM Cortex-A72 processor, and 32 GB SD card storage), is configured to:

Generate Cryptographic Keys: Produce a secret key pair (sᵢ,zᵢ), a hybrid product key hpkᵢ, and evaluation keys, stored in a memory (e.g. 256 MB of encrypted RAM).

Encrypt Plaintext: Convert plaintext bits into LWE ciphertext

$${c}_{i} = ( - 〈 {a}_{i} , {s}_{i} 〉 + \frac{q}{4} m + e , {a}_{i} ) ∈ {ℤ}_{q} \times {ℤ}_{q}^{n} ,$$

using a cyptographic co-processor for modular arithmetic.

Aggregate Ciphertexts: Contribute to forming the composite ciphertext c̅t̅, coordinated via the central node's API.

Perform Homomorphic Evaluation: Execute the noise-refreshing procedure which includes:
Fourier Transform-Based Rotation: Apply blind rotation in the Fourier domain, using a GPU (e.g., NVIDIA Jetson Nano) to achieve O(n log n) complexity for polynomial degree n.
Tensor Product-Based Multiplication: Perform tensor product-based multiplication with gadget decomposition and vector assembly to bound error growth. Construct a gadget vector v=(v₀, v₁, ···, v_{d-1}) via linear combinations of decomposed NTRU ciphertext components, computed on a CPU with, for example, 2 MB cache. The tensor products are assembled into an updated RLWE ciphertext, ensuring noise variance

$${σ}_{h p}^{2} \leq k {d}_{h p} {N}^{2} {V}_{h p} {σ}_{β}^{2} .$$

The system's parallel execution across participant nodes, supported by multi-core processors and distributed computing frameworks (e.g., Apache Spark), achieves quasi-linear complexity, enabling scalability for large k.

### Hardware Implementation

According to one embodiment of the present disclosure, The MK-FHE method and system are implemented on a distributed computing environment with the following hardware specifications:
Central Node: A cloud server with a 64-bit multi-core CPU (e.g., AMD EPYC with 16 cores), 32 GB DDR4 RAM, 500 GB NVMe SSD storage, and a 10 Gbps network interface for parameter distribution and coordination. The server runs a Linux-based OS (e.g., Ubuntu 22.04) with cryptographic libraries (e.g., OpenFHE, SEAL) for parameter generation and communication.
Participant Nodes: Edge devices or laptops with quad-core 64-bit processors (e.g., Intel Core i5 or ARM Cortex-A72), 4-8 GB RAM, 32-64 GB flash storage, and a cryptographic co-processor (e.g., TPM or AES-NI support). These devices support FFT computations via GPU accelerators (e.g., NVIDIA CUDA cores) and store keys and ciphertexts in encrypted memory partitions.
Network Infrastructure: A secure network with TLS 1.3 encryption, 1 Gbps bandwidth, and low-latency connections (e.g., <50 ms) to ensure efficient key and ciphertext exchange.
Storage Requirements: Approximately 1 MB per LWE ciphertext, 2-4 MB per RLWE/NTRU ciphertext, and 10 MB for key storage per node, enabling deployment on resource-constrained devices like IoT gateways.
Power Consumption: Participant nodes operate within a 5-10 W power envelope, suitable for battery-powered edge devices, while the central node consumes 100-200 W, typical for cloud servers.

This hardware configuration supports the method's efficiency, with blind rotation greatly reducing computation time compared to polynomial arithmetic, and NTRU's compact structures reducing memory usage compared to TFHE-based schemes. The system's design enables deployment in resource-constrained environments, such as edge computing networks for IoT or mobile devices.

The descriptions, examples, methods and materials presented in the claims and the specification are not to be construed as limiting but rather as illustrative only.

Meanings of technical and scientific terms used herein are to be commonly understood as by one of ordinary skill in the art to which the disclosure belongs, unless otherwise defined. The present disclosure may be implemented in the testing or practice with methods and materials equivalent or similar to those described herein.

While the disclosure has been described with respect to a limited number of embodiments, these should not be construed as limitations on the scope of the disclosure, but rather as exemplifications of some of the preferred embodiments. Other possible variations, modifications, and applications are also within the scope of the disclosure. Accordingly, the scope of the disclosure should not be limited by what has thus far been described, but by the appended claims and their legal equivalents.

What is claimed is,:

1. A computer-implemented method for multi-key fully homomorphic encryption, comprising:
generating a unified set of public parameters defining operational moduli and dimensions for learning with errors (LWE), ring learning with errors (RLWE), and NTRU-based encryption schemes;
producing, for each participant in a plurality of participants, independent cryptographic keys comprising a secret key pair for encryption and decryption operations, and a hybrid product key enabling merging of ciphertexts across LWE and RLWE structures;
transforming plaintext data into an initial encrypted form under a participant's secret key, yielding a participant-specific ciphertext compatible with LWE structures;
aggregating participant-specific ciphertexts from the plurality of participants to form a composite ciphertext operable under multiple keys;
conducting homomorphic evaluation of a logical operation on at least two composite ciphertexts, incorporating a noise-refreshing procedure that: integrates single-element LWE-based encrypted structures with multi-element RLWE-based encrypted structures through a gadget decomposition and tensor product-based multiplication process to generate an updated composite ciphertext; and
recovering the evaluated plaintext from the updated composite ciphertext by collaboratively applying the secret keys of all relevant participants.

2. The method of claim 1, wherein the step of generating a unified set of public parameters defining operational moduli and dimensions for LWE, RLWE, and NTRU comprises specifying an integer modulus q for LWE operations and a polynomial ring modulus Q for RLWE and NTRU operations; specifying a vector dimension n for LWE secrets and a polynomial ring dimension N for RLWE/NTRU secrets; and specifying noise distributions, gadget decomposition bases, and error bounds for all three encryption schemes.

3. The method of claim 1, wherein the secret key pair comprises an LWE secret vector
$${s}_{i} ∈ {ℤ}_{q}^{n}$$
and an RLWE secret key zᵢ ∈ R_{Q}; the hybrid product key is generated by sampling random elements rᵢ←χ_{σ}_{_{β}} and noise vector
$${e}_{i , 0} ← {𝒳}_{{σ}_{β}}^{{d}_{hp}} ,$$
computing
$${d}_{i , 0} = {r}_{i} \cdot a + {f}_{i} \cdot 𝔤 + {e}_{i , 0} ∈ {R}_{Q}^{{d}_{hp}} ,$$
computing
$${d}_{i , 2} = - {z}_{i} \cdot {d}_{i , 1} + {r}_{i} \cdot 𝔤 + {e}_{i , 1} ∈ {R}_{Q}^{{d}_{hp}} ,$$
and outputting a product key pair (d_{i,1}, d_{i,2}), a ciphertext merging key set is NKSK={nkskᵢ}_{2≤i≤d-1}, where
$${nksk}_{i} = {NTRU}_{f , Q}^{′} ( {B}^{i} ) .$$

4. The method of claim 1, wherein the step of transforming plaintext data into an initial encrypted form under a participant's secret key comprises sampling a random vector
$${a}_{i} ← {Z}_{q}^{n}$$
and noise term e←χ_{σ} computing a ciphertext component
$$b = - 〈 {a}_{i} , {s}_{i} 〉 + \frac{q}{4} m + e ,$$
outputung the ciphertext as a pair
$$( b , {a}_{i} ) ∈ {ℤ}_{q} \times {ℤ}_{q}^{n} ,$$
wherein sᵢ is the participant's LWE secret key.

5. The method of claim 1, wherein aggregating participant-specific ciphertexts from a plurality of participants by: receiving single-party LWE ciphertexts
$${c}_{j} = ( {b}_{j} , {a}_{j} ) ∈ {ℤ}_{q}^{n + 1}$$
for 1≤j≤k, where each cⱼ is encrypted under a distint participant's secret key; computing a joint offset term
$${b}_{s u m} = {\sum }_{j = 1}^{k} {b}_{j} ∈ {ℤ}_{q} ,$$
concatenating ciphertext vectors to form
$${a}_{j o i n t} = ( {a}_{1} , … , {a}_{k} ) ∈ {ℤ}_{q}^{k n} ;$$
outputting a composite ciphertext
$$\overline{c t} = ( {b}_{sum} , {a}_{j o i n t} ) ∈ {ℤ}_{q}^{k n + 1} ;$$
wherein the composite ciphertext is operable under a combination of all participants' secret keys for homomorphic evaluation or decryption.

6. The method of claim 1, wherein the noise-refreshing procedure during homomorphic evaluation comprises: computing decomposed components for each index j from 0 to d−1:vⱼ=c⊙nkskⱼ, constructing a gadget vector v=(v₀, v₁, ···, v_{d-1}), computing
$${c}_{j}^{′} = {𝔤}^{- 1} ( {c}_{j} ) \cdot v mod Q$$
and forming intermediate ciphertexts ĉ=(c′₀, c′₁, . . . , c′ₖ), applying HybridProduct to ĉ using public keys {bⱼ}_{j∈[k]}.

7. The method of claim 1, wherein recovering the evaluated plaintext comprises:
computing an inner product between the updated composite ciphertext
$$\overline{c t} = ( {\sum }_{j = 1}^{k} {b}_{j} , {a}_{1} , … , {a}_{k} ) ∈ {ℤ}_{q}^{k n + 1}$$
and the aggregated secret key vector (1,s̅), where s̅=(s₁, . . . sₖ) is the concatenation of all participants' secret keys, scaling and discretizing the result to recover a plaintext bit
$$m = ⌊ \frac{2}{q} ( 〈 \overline{c t} , ( 1 , \overline{s} ) 〉 ) ⌉ ∈ \{ 0 , 1 \} .$$

8. The method of claim 1, wherein the noise-refreshing procedure comprises:
initializing an accumulator ACC, executing blind rotation BREval in a Fourier domain, and merging ciphertexts via HybridProduct with noise variance bounded by: σ²≤k·dₕₚ·N²·Vₕₚ·σ_{β}², where k denotes the number of participants, dₕₚ denotes gadget decomposition dimension, N denotes ring dimension of RLWE/NTRU (R_{Q}= [symbol] _{Q}[X]/(X^{N}+1)), Vₕₚ denotes variance bound of gadget base B, σ_{β}² denotes variance of RLWE noise distribution.

9. The method of claim 8, wherein the blind rotation algorithm BREval comprises:
scaling coefficients
$${a}_{i}^{′} = \frac{2 N}{q} {a}_{i} ,$$
initializing ACC=X^{α}^{₀}⊙evk₀, iteratively updating
$$ACC ⊙ [ g + ( {X}^{{a}_{i}^{′}} - 1 ) \cdot {evk}_{i} ]$$
for 1≤i≤n−1.

10. The method of claim 8, wherein the noise-refreshing procedure executes in quasi-linear time relative to the number of parties k.

11. The method of claim 8, wherein the noise-refreshing procedure further comprises a ModSwitch operation comprising: receiving a multi-key LWE ciphertext
$$c = ( {c}_{0} , … , {c}_{k n} ) ∈ {ℤ}_{Q}^{k n + 1} ,$$
applying randomized rounding fuction [·]_{q:Q}: [symbol] _{Q}→ [symbol] _{q} defined as [x]_{q:Q}=└qx/Q┘+B, and outputting a refreshed ciphertext
$${c}^{′} = {( {[ {c}_{i} ]}_{q : Q} )}_{0 \leq i \leq k n} ∈ {ℤ}_{q}^{k n + 1} .$$

12. The method of claim 8, wherein the noise-refreshing procedure further comprises a KeySwitch operation comprising: receiving a multi-key LWE ciphertext
$$\overline{c t} = ( b , {a}_{1} , … , {a}_{k} ) ∈ {ℤ}_{q}^{kn + 𝟙} ,$$
for each paritipant j, 1≤j≤k, computing
$$( {b}_{j}^{′} , {a}_{j}^{′} ) = {\sum }_{i = 0}^{N - 1} {𝔤}^{- 1} ( {a}_{i , j} ) \cdot {lsks}_{j} ,$$
then outputting a transformed ciphertext
$$\overline{{ct}^{′}} = ( b + {\sum }_{i = 1}^{k} {b}_{i}^{′} , {a}_{1}^{′} , … , {a}_{k}^{′} ) .$$

13. A computing system configured for multi-key fully homomorphic encryption, comprising:
a central node configured to produce and disseminate a unified set of public parameters for LWE, RLWE, and NTRU-based encryption schemes; and
a plurality of participant nodes, each configured to: generate cryptographic keys including a secret key pair and a hybrid product key for ciphertext merging; convert plaintext data into a participant-specific ciphertext; contribute to aggregating participant-specific ciphertexts into a composite ciphertext; participate in homomorphic evaluation via a noise-refreshing procedure that integrates LWE and RLWE structures through gadget decomposition and tensor product-based multiplication; wherein the noise-refreshing procedure applies a Fourier transform-based rotation operation in a frequency domain.

14. The system of claim 13, wherein each participant node executes the noise-refreshing procedure by: performing tensor product-based multiplication with decomposition and vector assembly to bound error growth.

15. The system of claim 13, wherein the central node distributes parameters defining a noise distribution χ and gadget base B.

16. The system of claim 13, wherein each participant node performs the tensor product-based multiplication by constructing a vector v=(v₀, . . . , v_ {d−1}) via linear combinations of decomposed ciphertext components.

17. A non-transitory computer-readable storage medium storing instructions that, when executed by one or more processors, cause the processors to perform the method of claim 1.
